(19) United States
(12) Patent Application Publication
(10) Pub. No.: US 2019/0340116 A1
(43) Pub. Date: Nov. 7, 2019

(54) SHARED BACKUP UNIT AND CONTROL SYSTEM

(71) Applicant: MITSUBISHI ELECTRIC CORPORATION, Tokyo (JP)

(72) Inventor: Nobuhito MIYAUCHI, Tokyo (JP)

(73) Assignee: MITSUBISHI ELECTRIC CORPORATION, Tokyo (JP)

(21) Appl. No.: 16/470,171

(22) PCT Filed: Jan. 24, 2017
(86) PCT No.: PCT/JP2017/002340

§ 371 Date: Jun. 14, 2019

(51) Int. Cl. G06F 11/36

(52) U.S. Cl. CPC G06F 11/3692; B60R 16/0232; G06F 11/3688

(57) ABSTRACT

In a shared backup ECU, a diagnostic section diagnoses an abnormality in a plurality of ECUs which, in order to perform an individual function, execute a program that is different according to the function. A loading section loads, from a storage section storing a plurality of programs in advance, a program which is the same as a program to be executed by an abnormal unit being an ECU whose abnormality has been detected by the diagnostic section. An execution section executes the program loaded by the loading section, thereby performing a function which is the same as a function of the abnormal unit on behalf of the abnormal unit.

### TECHNICAL FIELD

The present invention relates to a shared backup unit and a control system.

### BACKGROUND ART

A self-diagnostic function is added to an ECU mounted in a commercially available automobile. Note that “ECU” is an abbreviation for Electronic Control Unit. When a trouble occurs, data at the moment is recorded and used as a reference material for repair. When an abnormality occurs in an input signal to the ECU, the input signal is switched to a standard value or reference value stored in the ECU, so that traveling of the car is enabled to thereby ensure functional safety. When an abnormality occurs in the ECU, an output is switched to a fixed signal of a backup IC, so that traveling of the car is enabled to thereby ensure functional safety. Note that “IC” is an abbreviation for Integrated Circuit.

In recent years, in an automated driving system whose development has been promoted at the national level, safety design is regarded as very important from the viewpoint of preventing accidents. The automobile today itself is a very complicated system. In order to ensure safety, ISO 26262 which is an international safety standard for automobiles has been formulated. With ISO 26262, a framework for systematically managing functional safety is determined. Product development process is regulated at the system level, hardware level, and software level of the automobile. Within this framework, risk stages are determined by a method based on the risk peculiar to the automobile. The components that constitute the system are organized by ASIL. Note that “ASIL” is an abbreviation for Automotive Safety

Regarding function classification based on ASIL, Non-Patent Literature 1 presents examples of its positioning, that is, market views. For example, loss of assistance in a turning function and loss of driving ability of a traveling function are positioned at a relatively moderate level of ASIL A or higher. In contrast, loss of braking function of a stopping function and steering wheel lock of a turning function are positioned at a critical level of ASIL C or higher. Design with consideration to risk management of various types of functions of the automobile is in need.

Particularly, in implementation of the ECU which is the core of the control process in an automated driving system, a multiplex system is adopted as in a space rocket and aircraft, so that the ECU will not be rendered uncontrollable even if a hardware failure occurs. Even if one channel in the multiplex system fails, as far as one remaining channel can operate normally, the ECU can continue execution processing. This ECU is generally called an ADAS ECU. Note that “ADAS” is an abbreviation for Advanced Driver Assistance System.

FIG. 15 shows a configuration example of a multiplex system of the automated driving system. Two decision ECUs 311 in FIG. 15 are ECUs that perform route determination processing of automated driving and constitute a duplex system. Pieces of output information from the two decision ECUs 311 are compared by a switching unit 361. If they do not coincide, it is determined that a failure has occurred, and a failing decision ECU 311 is disconnected from a CAN 711. Note that “CAN” is an abbreviation for Controller Area Network. Three control ECUs 211 in FIG. 15 are ECUs that control the engine and the steering wheel, and constitute a triplex system. Pieces of output information from the three control ECUs 211 are compared by a switching unit 261. If they do not coincide, a control ECU 211 which is the minority in the majority is determined as having failed and is disconnected from the CAN 711.

Automobiles have come to be mounted with many ECUs also in applications other than the automated driving system. Today the number of mounted ECUs also tends to rise remarkably. For example, many new ECUs have been added one after another such as an ECU for engine control aimed at exhaust gas reduction and a lower fuel cost as environmental measures, an ECU for airbag control aimed at an advanced safety function against accidents, an ECU for a pedestrian detection system and a braking assist function, an ECU for ETC (registered trademark) for convenience of the driver, and an ECU for a car navigation system. Note that “ETC” is an abbreviation for Electronic Toll Collection System.

The ECU has been taking charge of important functions. However, if simply multiplexing many ECU systems as a failure countermeasure, a great increase in hardware cost will be inevitable.

Website information which is published as examples of the multiplex system is indicated below.

In the technique described in Non-Patent Literature 2, fundamental subsystems are multiplexed to implement a function with which when one subsystem fails, it is complemented by another subsystem. The ECUs in this technique are provided with a fail-safe mechanism which ensures safe handling even if a failure should occur.

Non-patent Literature 3 introduces a triplex ECU of automobile steer-by-wire control. A fail-operational safety architecture including degeneration and continuation based on decision by majority of 3 sets of ECUs is provided.

Non-Patent Literature 4 describes development of an ECU with which when a malfunction or runaway occurs to a microcomputer in a sensor or travel control ECU, an abnormality is detected, and automatically a faulty channel is disconnected, so as to prevent an abnormal operation.

In the technique described in Non-Patent Literature 5, an ECU is composed of an A-channel CPU and a B-channel CPU. Note that CPU is an abbreviation for Central Processing Unit. The A-channel CPU and the B-channel CPU perform computation by the same program based on the same input information. The computation results are stored in the memories of the respective channels. The arithmetic results stored in the memories are checked by an FS comparison circuit. Note that “FS” is an abbreviation for Fail Safe. During continuation of a matching state, an FS relay goes ON and is in the output state. When a mismatch occurs, the FS relay goes OFF and is in an output cutoff state.

Patent Literatures adopting the multiplex system extensively will be indicated below.

Patent Literature 1 describes a technique relating to engine ECU multiplexing. In this technique, not only engine ECUs are multiplexed simply, but also the engine ECUs share roles and dynamically exchange the roles when a failure occurs.

In the technique described in Patent Literature 2, a plurality of standby-type nodes having different specifications are prepared for a plurality of execution-type nodes. When a trouble occurs in one execution-type node, a standby-type node that can eliminate the cause of the trouble is selected, and the selected standby-type node takes over data processing.

According to the technique described in Patent Literature 3, in a duplex configuration including two computers on the same network, one computer monitors the other computer and, in the event of a trouble, turns off the power supply of the other computer to disconnect the other computer from the network.

### CITATION LIST

### Patent Literature

Patent Literature 1: JP 2016-71771 A

Patent Literature 2: JP 2007-207219 A

Patent Literature 3: JP 2013-232142 A

### Non-Patent Literature

Non-Patent Literature 1: “Extraction of Work Items and Study for Conforming Software Tools Used in In-Vehicle System Development to Requirement Items of ISO 26262”, [online], February 2013, Information-Technology Promotion Agency [retrieved on Jan. 10, 2017,], Internet <URL: http:// www.ipa.go.jp/files/000026859.pdf

Non-Patent Literature 2: “Automated Driving”, [online], Japan Automobile Research Institute, [retrieved on Jan. 10, 2017], Internet <URL: http://www.jari.or.jp/tabid/111/Default.aspx>

Non-Patent Literature 3: KANEKO, Takanobu, NAKAMURA, Hideo, “Research of Safe Architecture in Advanced Driver Assistance System”, [online], June 2015, JARI Research Journal, [Retrieved on Jan. 10, 2017], Internet <URL: http://www.jari.or.jp/Portals/0/resource/JRJ_q/JRJ20150607_q_.pdf>

Non-Patent Literature 4: AOKI, Keiji, “Development Trend of Automated Driving Technology and Issues for Practical Application”, [online], Jan. 24, 2014, ISIT Car Electronics Research Group, [retrieved on Jan. 10, 2017], Internet <URL: http://www.car-electronics.jp/files/2013/11/CEW14_aoki. pdf>

Non-Patent Literature 5: “Research and Development of Automated Driving/Truck Platooning Technique”, [online], New Energy and Industrial Technology Development Organization [retrieved on Jan. 10, 2017], Internet <URL: http://www.nedo.go.jp/content/100095912.pdf>

### SUMMARY OF INVENTION

### Technical Problem

Past automobile systems have been designed to multiplex ECU systems which are important for handling failures. Today, the number of ECUs tends to rise remarkably. Therefore, if many ECU systems are multiplexed, a great increase in hardware cost will be inevitable.

As specific hardware, not only the microcomputers of the ECUs but also mounting boards and peripheral equipment such as the network interfaces, as well as network cables and housings increase. Wiring also increases, so the number of steps of wiring installation, wiring manufacturing, and wiring maintenance increases. This brings about an increase in the price of the automobile, which leads to an increase in the cost on the user side.

As the number of mounted electronic devices increases, the power consumption also increases. This also leads to the necessity of increasing the capacity of the battery to be mounted.

It is an objective of the present invention to enable substantial ECU multiplexing with less hardware.

### Solution to Problem

A shared backup unit according to one aspect of the present invention includes:

a diagnostic section to diagnose an abnormality in a plurality of electronic control units which, in order to perform an individual function, execute a program that is different according to the function;

a loading section to load, from a memory storing a plurality of programs in advance, a program which is the same as a program executed by an abnormal unit being an electronic control unit whose abnormality has been detected by the diagnostic section; and

an execution section to execute the program loaded by the loading section, thereby performing a function which is the same as a function of the abnormal unit on behalf of the abnormal unit.

### Advantageous Effects of Invention

According to the present invention, a shared backup unit can dynamically substitute for each ECU. Therefore, substantial ECU multiplexing becomes possible without preparing a backup unit for each ECU separately. That is, according to the present invention, substantial ECU multiplexing is possible with less hardware.

### BRIEF DESCRIPTION OF DRAWINGS

FIG. 1 is a block diagram illustrating a configuration of a control system according to Embodiment 1.

FIG. 2 is a block diagram illustrating a hardware configuration of the control system according to Embodiment 1.

FIG. 3 is a diagram illustrating an example of multitask cyclic processing in Embodiment 1.

FIG. 4 is a block diagram illustrating a configuration of a shared backup ECU according to Embodiment 1.

FIG. 5 is a diagram illustrating a succession example of a process to the shared backup ECU according to Embodiment 1.

FIG. 6 is a chart illustrating an example of a management table in the shared backup ECU according to Embodiment 1.

FIG. 7 is a flowchart illustrating an operation of the shared backup ECU according to Embodiment 1.

FIG. 8 is a flowchart illustrating a procedure of a backup-target SWC selection process of the shared backup ECU according to Embodiment 1.

FIG. 9 is a chart illustrating an example of a management table in a shared backup ECU according to Embodiment 2.

FIG. 10 is a flowchart illustrating a procedure of a backup-target SWC selection process of the shared backup ECU according to Embodiment 2.

FIG. 11 is a block diagram illustrating a configuration of a shared backup ECU according to Embodiment 3.

FIG. 12 is a diagram illustrating a succession example of a process to the shared backup ECU according to Embodiment 3.

FIG. 13 is a graph illustrating an example of output control curves of an accelerator pedal and engine throttle in Embodiment 3.

FIG. 14 is a flowchart illustrating an operation of the shared backup ECU according to Embodiment 3.

FIG. 15 is a block diagram illustrating a configuration example of a multiplex system of a conventional automated driving system.

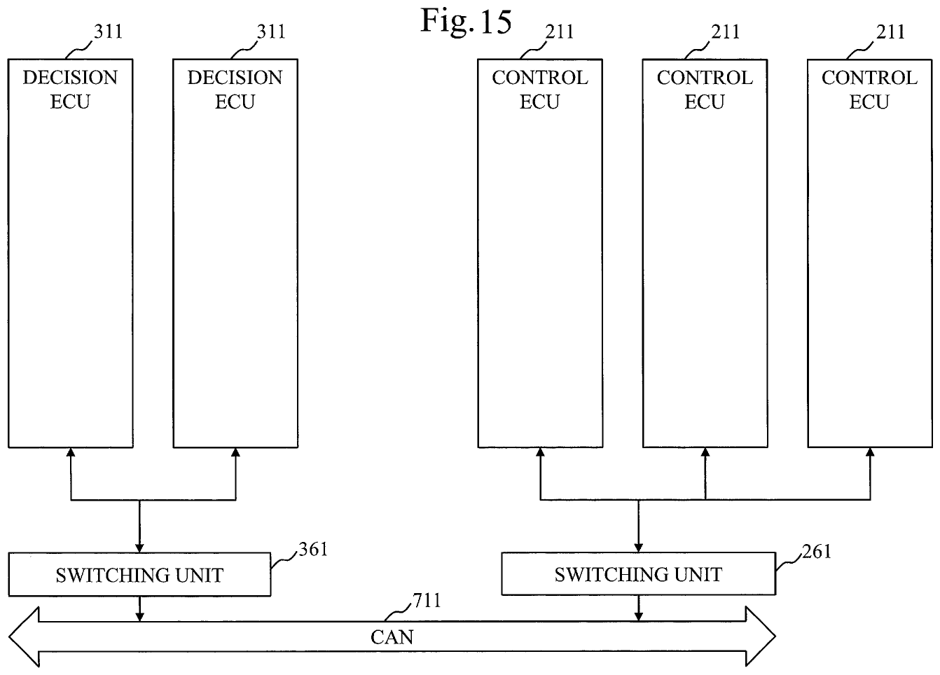

### DESCRIPTION OF EMBODIMENTS

Embodiments of the present invention will be described hereinafter with reference to drawings. In the drawings, the same or equivalent portions are denoted by the same reference numeral. The description for the same or equivalent portions of the embodiments will be omitted or simplified appropriately. The present invention is not limited to the embodiments described below, and various modifications can be made as necessary. For example, among the embodiments described below, two or more embodiments may be practiced in combination. Alternatively, among the embodiments described below, one embodiment or a combination of two or more embodiments may be partially practiced.

### Embodiment 1.

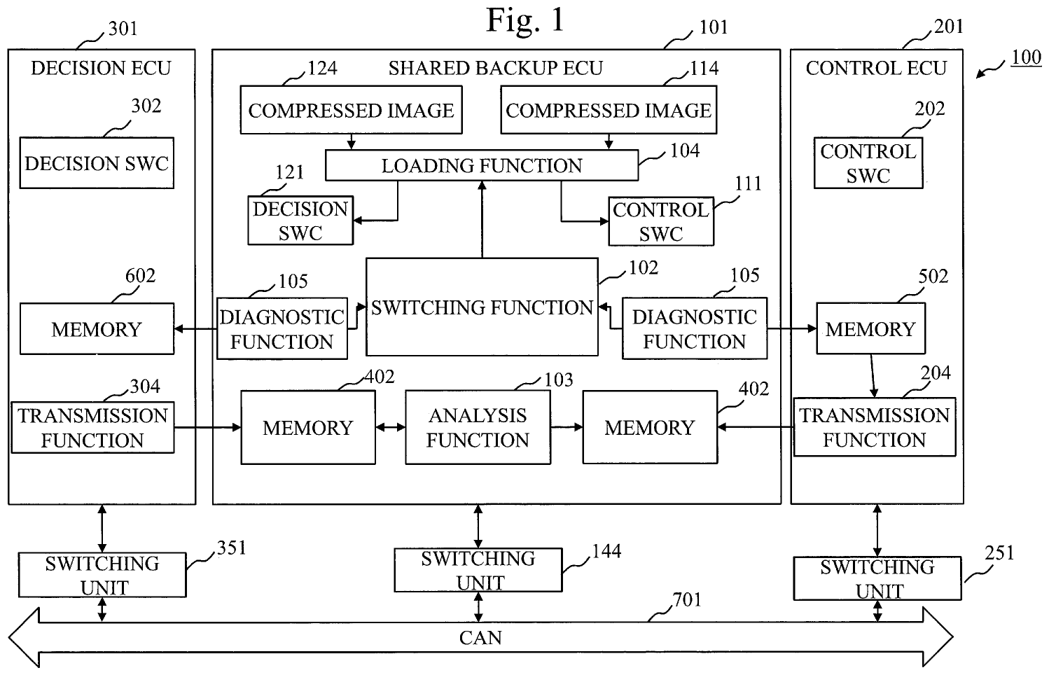

This embodiment will be described with reference to FIGS. 1 to 8.

***Description of Configuration***

A configuration of a control system 100 according to this embodiment will be described with reference to FIG. 1.

The control system 100 is provided with a plurality of electronic control units and a shared backup unit. The plurality of electronic control units, in order to perform an individual function, execute a program that is different according to the function.

The shared backup unit is capable of substituting for an arbitrary electronic control unit among the plurality of electronic control units.

In this embodiment, the control system 100 corresponds to an automated driving system.

The control system 100 is provided with an control ECU 201 and a decision ECU 301, as the plurality of electronic control units. The decision ECU 301 is an electronic control unit that executes a decision SWC 302, being a program that conducts a decision process of a driving route, in order to perform a function of deciding the driving route. Note that “SWC” is an abbreviation for Software Component. The control ECU 201 is an electronic control unit that executes a control SWC 202, which is a program to conduct a control process of the engine or steering wheel, in order to perform a function of controlling the engine or steering wheel.

The control system 100 is provided with a shared backup ECU 101 as a shared backup unit. The shared backup ECU 101 is a shared backup unit that functions as a backup when either one of the control ECU 201 and the decision ECU 301 fails.

In an actual case, a plurality of shared backup ECUs 101 will be provided in the entire system against failures in a plurality of ECUs. Then, when a shared backup ECU 101 itself fails, it can be switched to the second or third shared backup ECU 101. That is, the control system 100 suffices as far as it is provided with at least one shared backup unit, but in this embodiment, not only the shared backup ECU 101 illustrated in FIG. 1 but also one or more other shared backup ECUs 101 are provided as the plurality of shared backup units.

The shared backup ECU 101 is connected to a CAN 701 via a switching unit 144. The switching unit 144 has a function of disconnecting the shared backup ECU 101 from the CAN 701.

The control ECU 201 is connected to the CAN 701 via a switching unit 251. The switching unit 251 has a function of disconnecting the control ECU 201 from the CAN 701. When the control ECU 201 fails, the control ECU 201 is disconnected from the CAN 701 with using the switching unit 251.

The decision ECU 301 is connected to the CAN 701 via a switching unit 351. The switching unit 351 has a function of disconnecting the decision ECU 301 from the CAN 701. When the decision ECU 301 fails, the decision ECU 301 is disconnected from the CAN 701 with using the switching unit 351.

The CAN 701 may be replaced by another type of network such as LIN, FlexRay (registered trademark), and Ethernet (registered trademark). Note that “LIN” is an abbreviation for Local Interconnect Network. There is a case where another type of network is connected to the CAN 701 in a complicated manner. There is also a case where the network systems of a plurality of CANs 701 are connected to each other via a gateway or a network system selector switch. Examples of the network systems are a power train system including an engine and a steering control device, a multi-media system including a car navigation system and a car audio device, a body system including power windows and electric seats, and a switch/sensor system including various types of sensors and actuators.

In this embodiment, an increase in hardware cost can be reduced by sharing, among the ECUs, the shared backup ECU 101 that can be used when a failure occurs, instead of multiplexing every single ECU.

The shared backup ECU 101 has a switching function 102, an analysis function 103, a loading function 104, and a diagnostic function 105. The switching function 102 is a function of switching a backup-target ECU. The analysis function 103 is a function of analyzing a CAN message. The loading function 104 is a function of decompressing a compressed image of an SWC and loading the decompressed image. The diagnostic function 105 is a function of analyzing an abnormality in an external ECU. By these functions, the shared backup ECU 101 activates, on a memory 402, a group of a necessary minimum number of SWCs to be mounted on the backup-target ECU, and executes a backup process. More specifically, the shared backup ECU 101 activates a control SWC 111 when substituting for the control ECU 201. The shared backup ECU 101 activates a decision SWC 121 when substituting for the decision ECU 301. The shared backup ECU 101 stands by after the OS is activated so that when a failure occurs, an SWC for continuous processing can be executed immediately. Note that “OS” is an abbreviation for Operating System.

When using the shared backup ECU 101, the network interface of the failing ECU is disconnected or switched, or the power supply of the failing ECU is cut off.

Information on a state and learning of the failing ECU is necessary for the continuous processing for backup, and this information must be prepared in advance during the normal operation. An arbitrary method may be used for preparing this information. This embodiment uses a method of saving such information to an independent memory area away from the failing ECU. More specifically, the control ECU 201 reads the information necessary for succession of the process of the control SWC 202, from a memory 502. The control ECU 201 transmits the readout information to the shared backup ECU 101 by a transmission function 204 via the CAN 701. The shared backup ECU 101 receives the information transmitted from the control ECU 201. The shared backup ECU 101 stores the received information to the memory 402. Similarly, the decision ECU 301 reads information necessary for succession of the process of decision SWC 302, from a memory 602. The decision ECU 301 transmits the readout information to the shared backup ECU 101 by a transmission function 304 via the CAN 701. The shared backup ECU 101 receives the information transmitted from the decision ECU 301. The shared backup ECU 101 stores the received information to the memory 402.

In this embodiment, a mechanism for receiving a failure detection signal from a monitoring-target ECU by the shared backup ECU 101 is prepared. More specifically, examples are a mechanism that detects an error detection signal, a mechanism that receives a heartbeat signal, and a mechanism that receives information from a self-diagnostic circuit or the like.

In this embodiment, instead of executing all pieces of software of the failing ECU, the shared backup ECU 101 having a relatively low performance conducts priority execution of a piece of software that is indispensible for continuous driving. For this purpose, the shared backup ECU 101 manages the SWCs based on ASIL and selects an SWC to be executed. According to this embodiment, a shared backup unit comparable with multiplexing a large number of ECUs need not be prepared.

According to this embodiment, aiming at being able to selectively activate the SWCs of many ECUs within the limited memory capacity of the shared backup ECU 101, the shared backup ECU 101 compresses a memory-loaded image of an SWC and holds the compressed image. When necessary, the shared backup ECU 101 decompresses the compressed image and performs SWC succession. More specifically, when substituting for the control ECU 201, the shared backup ECU 101 decompresses a compressed image 114 of the control SWC 111 and activates the control SWC 111. When substituting for the decision ECU 301, the shared backup ECU 101 decompresses a compressed image 124 of the decision SWC 121 and activates the decision SWC 121.

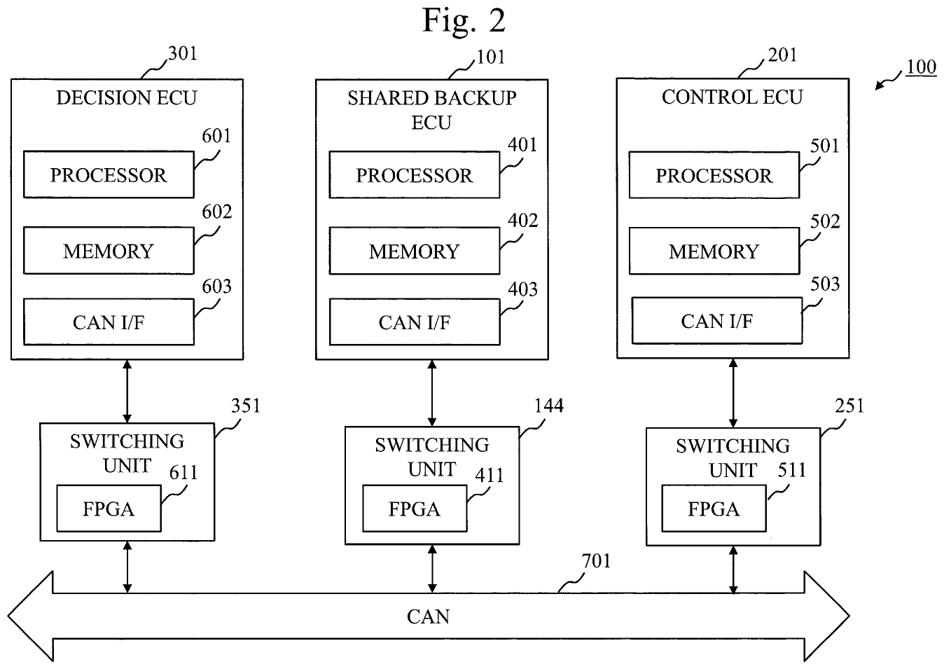

The hardware configuration of the control system 100 will be described with reference to FIG. 2.

The shared backup ECU 101 is a microcomputer. The shared backup ECU 101 is provided with a processor 401 as well as other hardware devices such as the memory 402 and a CAN interface 403. The processor 401 is connected to the other hardware devices via signal lines and controls these other hardware devices.

The processor 401 is an IC that performs various types of processes. The processor 401 is more specifically a CPU.

The memory 402 is a flash memory or RAM, for example. Note that “RAM” is an abbreviation for Random Access Memory.

The CAN interface 403 includes a receiver to receive data and a transmitter to transmit data. The CAN interface 403 is a communication chip or NIC, for example. Note that “NIC” is an abbreviation for Network Interface Card. The CAN interface 403 may be replaced by a USB interface. Note that “USB” is an abbreviation for Universal Serial Bus.

The shared backup ECU 101 may be provided with a plurality of processors that replace the processor 401. Each processor is an IC that performs various types of processes, as the processor 401 does.

The switching unit 144 is provided with an FPGA 411. Note that “FPGA” is an abbreviation for Field-Programmable Gate Array.

The control ECU 201 is a microcomputer. The control ECU 201 is provided with a processor 501 as well as other hardware devices such as the memory 502 and a CAN interface 503. The processor 501 is connected to the other hardware devices via signal lines and controls these other hardware devices.

The processor 501, memory 502, and CAN interface 503 are the same as the processor 401, memory 402, and CAN interface 403, respectively, of the shared backup ECU 101.

The control SWC 202 is stored in the memory 502. The control SWC 202 is read by the processor 501 and executed by the processor 501.

The switching unit 251 is provided with an FPGA 511.

The decision ECU 301 is a microcomputer. The decision ECU 301 is provided with a processor 601 as well as other hardware devices such as the memory 602 and a CAN interface 603. The processor 601 is connected to the other hardware devices via signal lines and controls these other hardware devices.

The processor 601, memory 602, and CAN interface 603 are the same as the processor 401, memory 402, and CAN interface 403, respectively, of the shared backup ECU 101.

The decision SWC 302 is stored in the memory 602. The decision SWC 302 is read by the processor 601 and executed by the processor 601.

The switching unit 351 is provided with an FPGA 611.

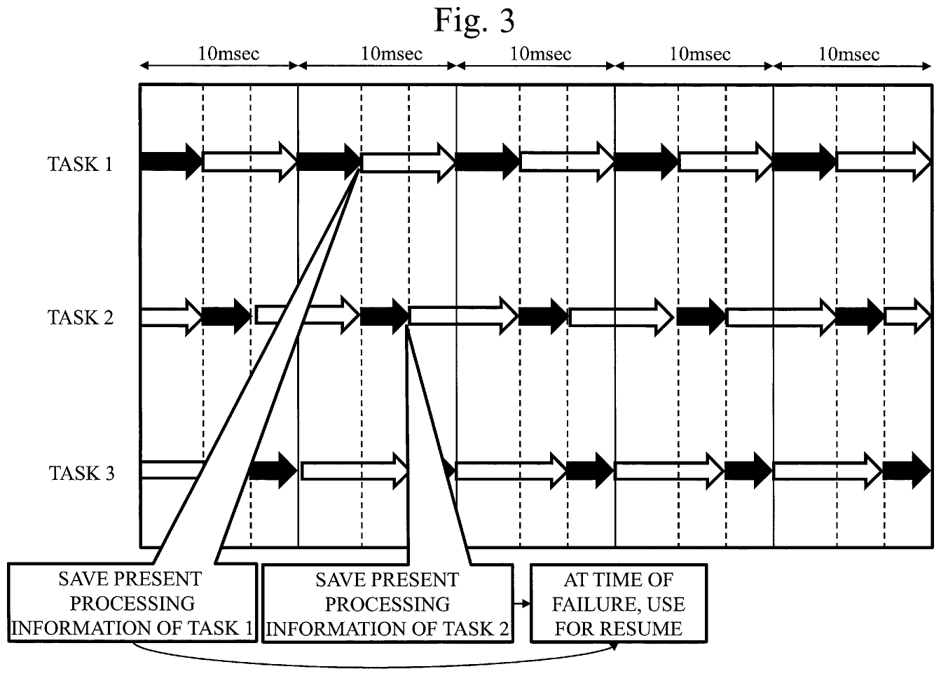

A general implementation mode of embedded software in an ECU will be described with reference to FIG. 3. In this embodiment, this implementation mode is applied to a backup-target ECU as well as the shared backup ECU 101. In FIG. 3, a solid arrow indicates a task-executing state, and a blank arrow indicates a task execution standby state.

Basically, the application software on the embedded OS is often executed in a multitask environment, as illustrated in FIG. 3. Even if the processing is interrupted at the time of failure, if an individual task variable, a shared variable, or a global variable, and present information such as learned/stored information of the behavior of the application are accumulated in the memory 402, then with reusing the accumulated information, it is possible to execute continuous processing by the shared backup ECU 101.

If the execution cycle of the application software is a relatively short cycle of up to about several tens of milliseconds, continuous processing by the shared backup ECU 101 is easy. More specifically, it is possible to use the information saved together as a set of inputting accumulation information at the processing start time.

When, however, resuming execution of processing of the application software that went down in the middle of a cycle, processing of that cycle must performed again from the beginning, leading to a delay.

There is also a possibility that the application software may go down during the save of the inputting accumulation information of each cycle. Therefore, a save completion flag is prepared. Whether the save is completed can be judged from ON/OFF of this flag. If two save areas for the inputting accumulation information are reserved, even if writing for saving in one area is incomplete, past information stored in the other area may be used, so that an influence can be suppressed to only one-cycle delay.

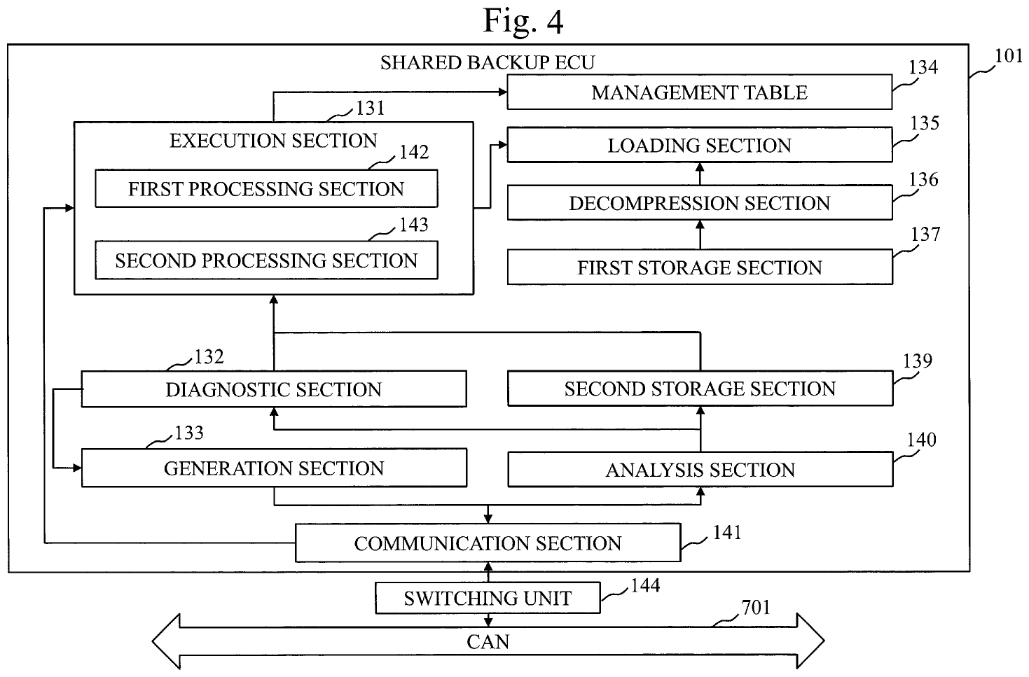

A configuration of the shared backup ECU 101 according to this embodiment will be described with reference to FIG. 4.

The shared backup ECU 101 is provided with an execution section 131, a diagnostic section 132, a generation section 133, a management table 134, a loading section 135, a decompression section 136, a first storage section 137, a second storage section 139, an analysis section 140, and a communication section 141, as functional elements. The execution section 131 is provided with a first processing section 142 and a second processing section 143. The functions of the execution section 131, diagnostic section 132, generation section 133, loading section 135, decompression section 136, and analysis section 140 are implemented by software. The management table 134, the first storage section 137, and the second storage section 139 are implemented by the memory 402. The communication section 141 is implemented by the CAN interface 403.

A shared backup program which is a program to implement the functions of the execution section 131, diagnostic section 132, generation section 133, loading section 135, decompression section 136, and analysis section 140 is stored in the memory 402. The shared backup program is read by the processor 401 and executed by the processor 401. The OS is also stored in the memory 402. The processor 401 executes the shared backup program while executing the OS. The shared backup program may be embedded in the OS partly or entirely.

Information, data, signal values, and variable values representing the processing results of the execution section 131, diagnostic section 132, generation section 133, loading section 135, decompression section 136, and analysis section 140 are stored in the memory 402, or in a register or cache memory in the processor 401.

Alternatively, the shared backup program may be stored in a portable recording medium such as a magnetic disk or optical disk.

***Description of Operation***

The outline of the operation of the shared backup ECU 101 according to this embodiment will be described with reference to FIG. 1. The operation of the shared backup ECU 101 corresponds to a backup method according to this embodiment.

The shared backup ECU 101 examines the CAN message having arrived via the CAN 701 by the analysis function 103, and detects a failure in the decision ECU 301 or control ECU 201 by the diagnostic function 105. Alternatively, it is possible to implement a method according to which the decision ECU 301 or control ECU 201 is provided with a self-diagnostic function and transmits a CAN message of the time a failure has occurred, to the shared backup ECU 101.

Upon detection of a failure, the shared backup ECU 101 looks up the management table 134 by the switching function 102, selects an SWC to be backed up, and extracts a compressed image of the corresponding SWC. More specifically, the shared backup ECU 101 extracts the compressed image 124 of the decision SWC 121, or the compressed image 114 of the control SWC 111. The shared backup ECU 101 loads the compressed image onto the execution memory by the loading function 104 and executes the corresponding SWC. More specifically, the shared backup ECU 101 executes the decision SWC 121 or control SWC 11.

The shared backup ECU 101 transmits a CAN message being a disconnection instruction to the switching unit 351 or switching unit 251 so that the failing decision ECU 301 or the failing control ECU 201 will not perform a transmission/reception process of an abnormal CAN message.

An operation of the shared backup ECU 101 will be described in detail with reference to FIG. 4.

The communication section 141 connects to the CAN 701 and performs a transmission/reception process of a CAN message. The communication section 141 transfers the received CAN message to the first processing section 142 and analysis section 140. The first processing section 142 processes the received CAN message of the time the SWC is activated and executed. The second processing section 143 transfers a transmission CAN message of the time the SWC is activated and executed to the communication section 141. The generation section 133 transfers a transmission CAN message for the switching unit 144 to the communication section 141.

The analysis section 140 transfers information concerning a diagnosis-target ECU to the diagnostic section 132. The diagnostic section 132 determines whether the ECU has failed. Upon detection of a failure, the diagnostic section 132 transmits failure detection information to the execution section 131 and generation section 133. The analysis section 140 transmits CAN message information of the time the diagnosis-target ECU operates normally to the second storage section 139 and stores the CAN message information in the second storage section 139.

When the failure is reported by the diagnostic section 132, the execution section 131 looks up the management table 134 and selects an SWC that needs to be backed up. The execution section 131 reads a necessary memory image from the first storage section 137 and decompresses the memory image by the decompression section 136. The execution section 131 loads the memory image onto the memory 402 by the loading section 135. Then, the execution section 131 activates and executes this SWC.

In this embodiment, as described, the diagnostic section 132 diagnoses an abnormality in the plurality of ECUs. The loading section 135 loads, from the memory 402 storing a plurality of programs in advance, a program which is the same as a program executed by an abnormal unit being an ECU whose abnormality has been detected by the diagnostic section 132. The execution section 131 executes the program loaded by the loading section 135, thereby performing a function which is the same as a function of the abnormal unit on behalf of the abnormal unit.

As a specific example, assume that the diagnostic section 132 has detected an abnormality of the control ECU 201. In this case, the loading section 135 loads the control SWC 111, being a program which is the same as the control SWC 202 executed by the control ECU 201, from the memory 402. By executing the control SWC 111 loaded by the loading section 135, the execution section 131 performs a function of controlling the engine or steering wheel on behalf of the control ECU 201.

The communication section 141 receives an individual message indicating a state variable which the plurality of ECUs use during execution of the program, from the plurality of ECUs. The execution section 131 sets a state variable to be used when executing the program loaded by the loading section 135, based on the messages received by the communication section 141 from the abnormal unit prior to detection of the abnormality by the diagnostic section 132.

As a specific example, assume that the diagnostic section 132 detects an abnormality of the control ECU 201. In this case, the execution section 131 sets a state variable of the control SWC 111 loaded by the loading section 135, in accordance with a state variable of the control SWC 202 indicated by a CAN message received by the communication section 141 from the control ECU 201 prior to detection of the abnormality by the diagnostic section 132.

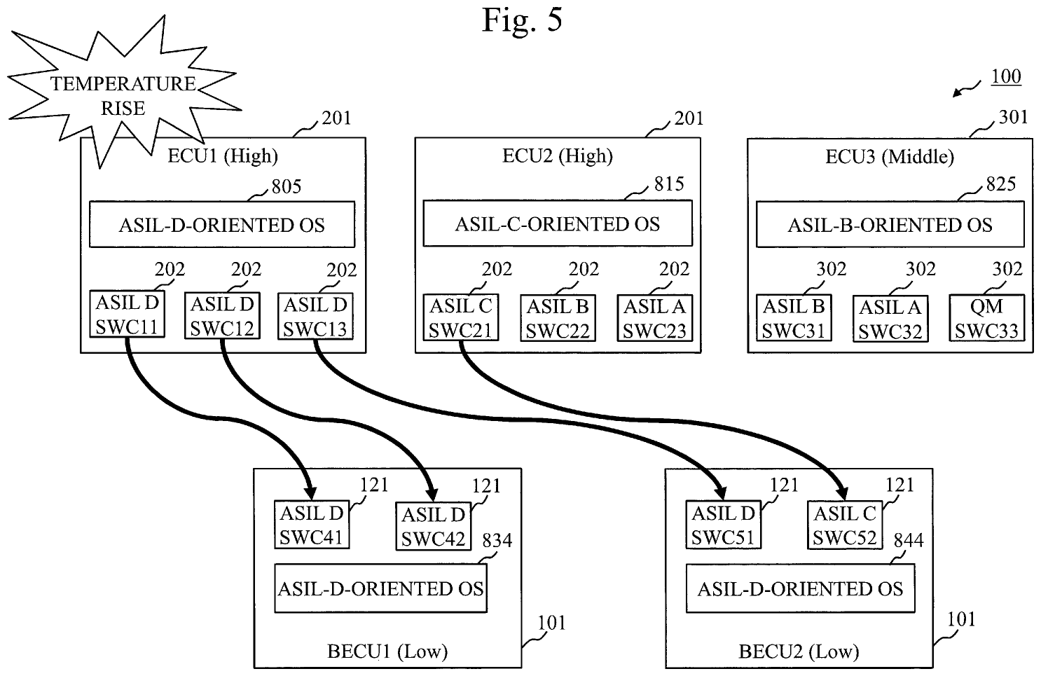

As for the management table 134 being provided, a table is not necessarily indispensable because a selection process itself of the SWC can be realized by a branch process of an if-sentence or the like of a program. Nevertheless, a table is recommended since it facilitates implementation and maintenance of the setting process of the SWC. flow the SWC is selected will be specifically described with reference to the example of FIG. 5.

In the example of FIG. 5, as ECUs that operate normally, there are three ECUs which are a high-performance ECU1, a high-performance ECU2, and a middle-performance ECU3. Each of the ECU1 and ECU2 corresponds to the control ECU 201. The ECU3 corresponds to the decision ECU 301. In the ECU1, three SWCs which are an ASIL D SWC11, an ASIL D SWC12, and an ASIL D SWC13, operate each as the control SWC 202, on an ASIL-D-oriented OS 805. In the ECU2, three SWCs which are an ASIL C SWC21, an ASIL B SWC22, and an ASIL A SWC23, operate each as the control SWC 202, on an ASIL-C-oriented OS 815. In the ECU3, three SWCs which are an ASIL B SWC31, an ASIL A SWC32, and a QM SWC33, operate each as the decision SWC 302, on an ASIL-B-oriented OS 825.

In contrast, there are two shared backup ECUs 101 which are a low-performance BECU 1 and a low-performance BECU2. In the BECU 1, an ASIL-D-oriented OS 834 is running. In the BECU2, an ASIL-D-oriented OS 844 is running.

In the example of FIG. 5, backup to the shared backup ECU 101 takes place not when the ECU fails completely but when a possibility occurs that the ECU1, ECU2, and ECU3 may fail due to a temperature rise. The SWC to be selected as the backup target is an SWC having an ASIL of C or more. This rests on the premise that a worst case can be avoided, even if the SWC having an ASIL of B or less does not operate.

Suppose that due to a temperature rise, a possibility occurs that the ECU1, ECU2, and ECU3 may fail, or actually the ECU1, ECU2, and ECU3 have failed. In this case, the ASIL D SWC11 and ASIL D SWC12 in the ECU1 are backed up to the BECU1, and the ASIL D SWC13 in the ECU1 and the ASIL C SWC21 in the ECU2 are backed up to the BECU2. As a result, in the BECU1, an ASIL D SWC41 and an ASIL D SWC42 are executed, each as the control SWC 111, on the ASIL-D-oriented OS 834. In the BECU2, an ASIL D SWC51 and an ASIL C SWC52 are executed, each as the control SWC 111, on the ASIL-D-oriented OS 844. The other SWCs having an ASIL of B or less are not backed up.

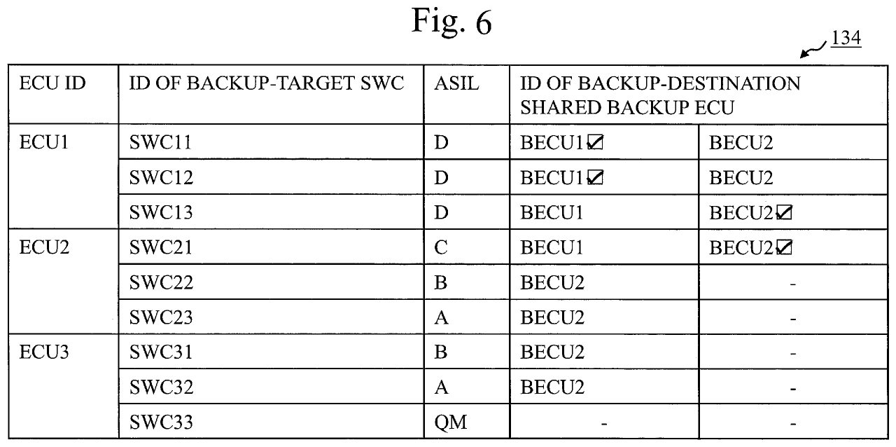

FIG. 6 illustrates an example of the management table 134 used in the example of FIG. 5.

Regarding the ECU1, ECU2, and ECU3 that operate usually, the ID of the backup-target SWC and the ID of the shared backup ECU 101 as a backup destination are registered separately. Note that “ID” is an abbreviation for Identifier. ASIL information is added to the ID of each backup-target SWC. Since there are two shared backup ECUs 101, the IDs of the shared backup ECU 101 as the backup destination are assigned to two entries in the management table 134. A shared backup ECU 101 is always assigned to an SWC having an important ASIL as the backup destination. 1 or 0 of backup destination is assigned to an SWC having a low-level ASIL.

In the example of failure described above, among the backup-target SWCs, the SWC11 and SWC13 are assigned to the BECU1, and the SWC13 and SWC21 are assigned to the BECU2. The allotting rule is that a maximum of two SWCs are operated in the shared backup ECU 101. When a failure occurs, the backup-destination shared backup ECU 101 is assigned. When the backup process is completed, an in-use flag of the backup-destination shared backup ECU 101 in the management table 134 is set up. Thus, when an ECU fails next time, not the same shared backup ECU 101 but a shared backup ECU 101 that is not in use can be selected.

In this manner, according to this embodiment, when an abnormal unit is an ECU that executes two or more programs, the execution section 131 selects a program to be loaded by the loading section 135 according to the priority defined in advance for each program. When an abnormality in two or more ECUs is detected by the diagnostic section 132, the execution section 131 selects a program to be loaded by the loading section 135 according to the priority defined in advance for each combination of an ECU and a program. Regarding the definition of the priority, an arbitrary definition may be employed. In this embodiment, ASIL is employed, as mentioned above.

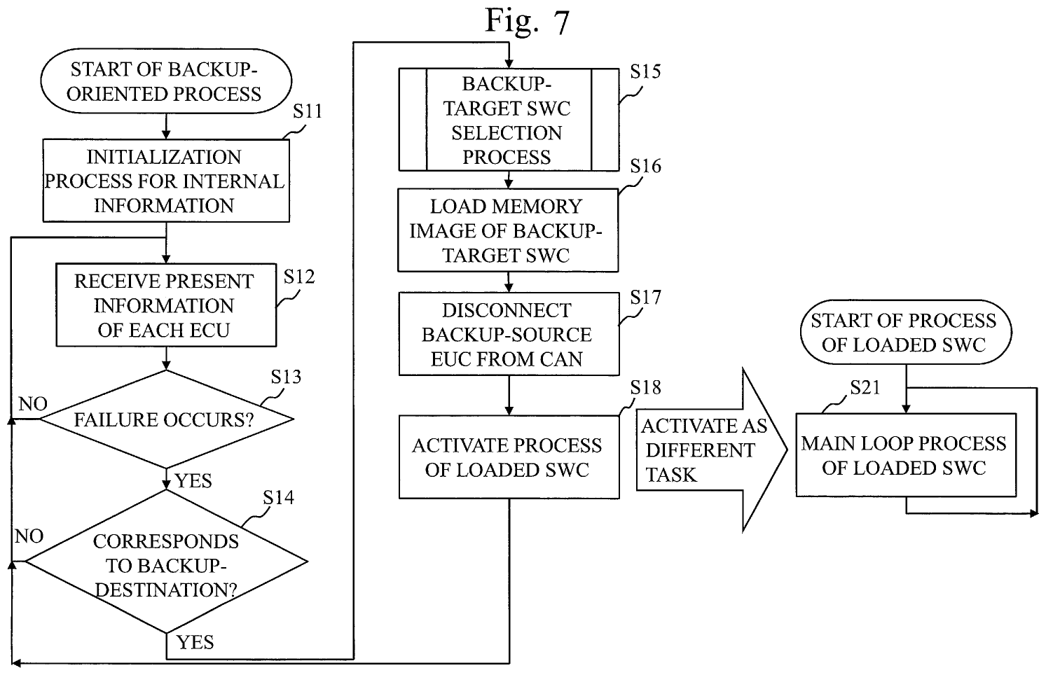

The processing procedure of the shared backup program which operates in the shared backup ECU 101 will be described with reference to FIG. 7. In an automobile, once the engine is started and the power supply is turned on, a backup-oriented process of the shared backup ECU 101 is executed continuously until the power supply is cut off by engine stop.

When the power supply is turned on and the backup-oriented process is started, an initialization process for internal information is executed in step S11. The communication section 141 starts acquisition of the CAN message on the CAN 701.

In step S12, the analysis section 140 receives the present information of each ECU serving as a backup source and saves the received present information to the second storage section 139. Each ECU serving as the backup source will continuously transmit the present information to the shared backup ECU 101. Alternatively, in order to reduce the message size, each backup-source ECU may compress the present information itself and transmit the compressed present information, and the transmitted compressed present information may be decompressed by the shared backup ECU 101.

In step S13, the diagnostic section 132 confirms whether a failure has occurred in any ECU, from the result of analysis of the CAN message by the analysis section 140. If no failure has occurred, a loop process is repeatedly performed again starting with the process of step S12. The diagnostic section 132 detects occurrence of a failure not only from the result of analysis of the received CAN message. If a CAN message that should be received periodically does not arrive, the diagnostic section 132 detects this case also as occurrence of a failure.

If a failure occurs, in step S14, the execution section 131 confirms whether this shared backup ECU 101 corresponds to a backup destination. If this shared backup ECU 101 does not correspond to a backup destination, the loop process is repeatedly performed again starting with the process of step S12.

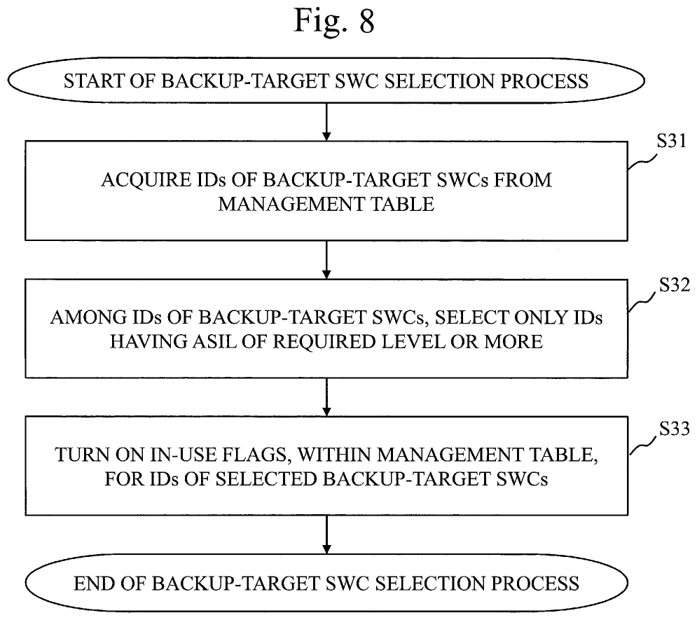

If the shared backup ECU 101 corresponds to a backup destination, then in step S15, the execution section 131 looks up the management table 134 and executes a backup-target SWC selection process of selecting a backup-target SWC. FIG. 8 illustrates a procedure of the backup-target SWC selection process. In step S31, the execution section 131 acquires the IDs of backup-target SWCs from the management table 134. In step S32, among the IDs of the backup-target SWCs, the execution section 131 selects only IDs having an ASIL of a required level or more. In step S33, the execution section 131 turns on the in-use flags of the IDs of the selected backup-target SWCs, within the management table 134.

Update of the in-use flag of the management table 134 should be transmitted to the management table 134 of another shared backup ECU 101 as well by a CAN message or the like. Actually, however, update can be dealt with without being transmitted to the management table 134, since failure detection has been done in the other shared backup ECU 101 as well.

In step S16, the loading section 135 acquires the memory image of the SWC selected in step S15 from the first storage section 137. The loading section 135 decompresses the acquired memory image by the decompression section 136. The loading section 135 loads the decompressed memory image onto the memory 402.

In step S17, the execution section 131 disconnects the backup-source ECU from the CAN 701 by operating the switching unit connected to the backup-source ECU. More specifically, if the backup-source ECU is the control ECU 201, the execution section 131 transmits a CAN message instructing disconnection to the switching unit 251 by the communication section 141. If the backup-source ECU is the decision ECU 301, the execution section 131 transmits a CAN message instructing disconnection to the switching unit 351 by the communication section 141.

In step S18, the execution section 131 activates the process of the SWC loaded in step S16. This process of the SWC is activated as a different task independent of the main loop process of the backup-oriented process.

When the process of the loaded SWC is started, then in step S21, the execution section 131 executes the main loop process of the loaded SWC.

### Description of Advantageous Effects of Embodiment

In this embodiment, the shared backup ECU 101 can dynamically substitute for each ECU. Hence, the ECUs can be substantially multiplexed without preparing backup units for the respective ECUs separately. That is, according to this embodiment, the ECUs can be substantially multiplexed with less hardware.

In this embodiment, the shared backup ECU 101 is provided with the execution section 131, diagnostic section 132, loading section 135, first storage section 137, second storage section 139, analysis section 140, and communication section 141. The communication section 141 connects to the network and performs a message transmission/reception process. The analysis section 140 analyzes a received message. The diagnostic section 132 determines from the analysis result of the message whether any other ECU fails. When a failure of any other one of the plurality of ECUs is detected, the first processing section 142 of the execution section 131 activates not necessarily all of the substitute software components for backup, but selects a suitable substitute software component individually according to the necessity level for continuous execution and activates the selected substitute software component. The second processing section 143 of the execution section 131 generates a disconnect instruction message to be transmitted to a switching unit to which the failing ECU is connected, and transfers the generated disconnect instruction message to the communication section 141. The first storage section 137 stores execution memory images of the substitute software components of the other plurality of ECUs in advance. The loading section 135 loads the execution memory images to the execution memory.

According to this embodiment, the total number of ECUs increasing when the ECUs are multiplexed can be reduced by sharing the backup ECU. As a result, an increase in hardware production cost and power consumption can be suppressed.

In this embodiment, it is possible to select an important SWC which is indispensable for continuous operation, as a backup-target SWC, and operate the selected SWC on the shared backup ECU 101 limitedly. Therefore, a high-performance ECU need not always be employed as the backup ECU, so that an increase in hardware production cost and power consumption can be further suppressed.

In multiplex ECU system, if the ECUs are duplex, the process will collapse when two ECUs fail. If the ECUs are triplex, the process will collapse when three ECUs fail. By sharing the backup ECUs, however, a large number of backup ECUs can be utilized by each ECU. As a result, the durability against continuous operation is better than that of stationary multiplex ECUs.

In multiplex ECU system, the multiplexed ECUs will be disposed together on a board because of the hardware configuration limitations. In cases where a local failure occurs in the automobile and accordingly damage to the multiplex ECU board due to a temperature rise and so on is anticipated, there is a possibility that the entire multiplex ECUs might be damaged simultaneously. In contrast to this, since the shared backup ECUs 101 can be disposed separately on separate boards, entire breakdown of the ECUs due to the influence of a local failure can be avoided. As a result, durability against continuous operation is better than that of a centralized multiplex ECU configuration.

***Other Configurations***

In this embodiment, the control system 100 corresponds to an automated driving system. In a modification, a control system 100 may be implemented as a system other than an automated driving system. In particular, the control system 100 can be utilized in machines and devices in general in which very many microcomputers are incorporated, operation processing is performed by electronic control, countermeasures against ECU failure are required, and a multiplex system configuration is desired. Examples of such machines and devices are a space rocket, an artificial satellite, an aircraft, an electric railcar, a vessel, a submarine, a machine tool, a construction machine, a medical machine, a robot, and so on.

In this embodiment, the functions of the execution section 131, diagnostic section 132, generation section 133, loading section 135, decompression section 136, and analysis section 140 are implemented by software. In a modification, the functions of an execution section 131, diagnostic section 132, generation section 133, loading section 135, decompression section 136, and analysis section 140 may be implemented by a combination of software and hardware. That is, some of the functions of the execution section 131, diagnostic section 132, generation section 133, loading section 135, decompression section 136, and analysis section 140 may be implemented by a dedicated electronic circuit, and the remaining functions may be implemented by software.

The dedicated electronic circuit is, for example, a single circuit, a composite circuit, a programmed processor, a parallel-programmed processor, a logic IC, a GA, an FPGA, or an ASIC. Note that “GA” is an abbreviation for Gate Array, and that “ASIC” is an abbreviation for Application Specific Integrated Circuit.

The processor 401, the memory 402, and the dedicated electronic circuit are collectively called “processing circuitry”. That is, whether the functions of the execution section 131, diagnostic section 132, generation section 133, loading section 135, decompression section 136, and analysis section 140 may be implemented by software or a combination of software and hardware, the functions of the execution section 131, diagnostic section 132, generation section 133, loading section 135, decompression section 136, and analysis section 140 are implemented by processing circuitry.

“ECU” of the shared backup ECU 101 may be differently read as “program”, “program product”, or “computer readable medium storing a program”. Also, “section” of the execution section 131, diagnostic section 132, generation section 133, loading section 135, decompression section 136, and analysis section 140 may be differently read as “procedure” or “process”.

### Embodiment 2

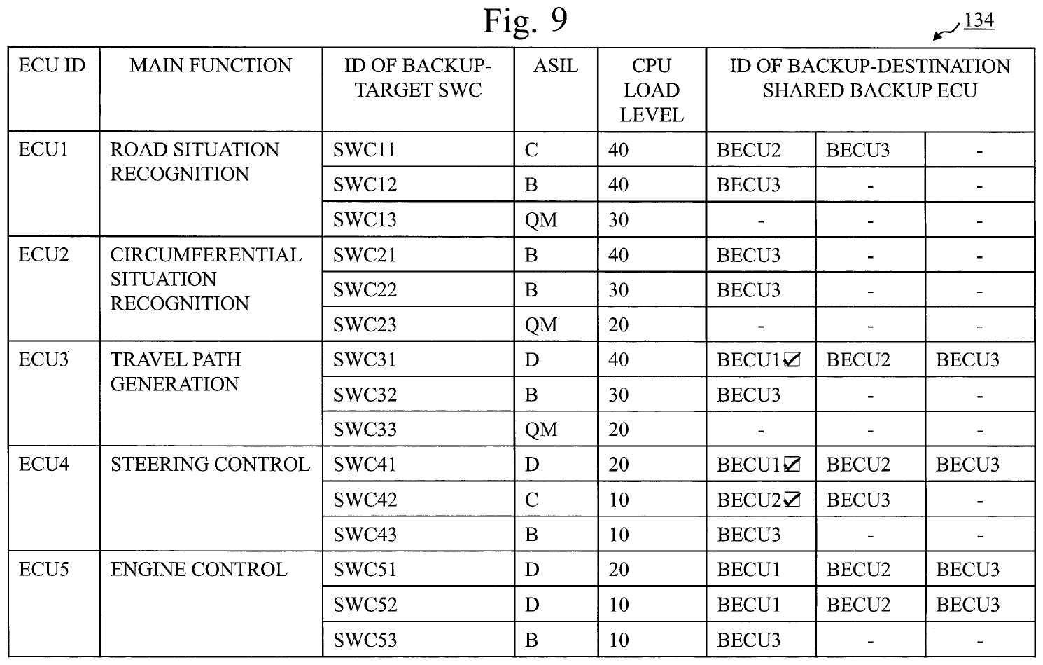

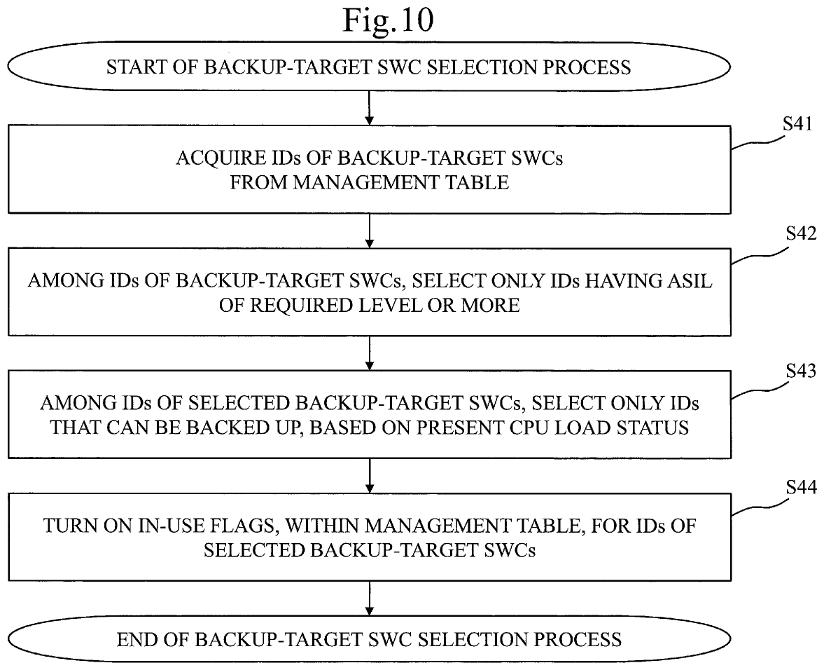

Embodiment 2 will be described mainly regarding differences from Embodiment 1 with reference to FIGS. 9 and 10.

In Embodiment 1, the necessity level for continuous execution of each software component is stored in the management table 134. In Embodiment 2, the CPU load during execution of each software component is additionally stored in a management table 134. A shared backup ECU 101 selects an individual software component among software components of a plurality of ECUs in accordance with the calculation result of the CPU load such that the total capacity of the CPU loads does not exceed the upper limit.

***Description of Configuration*** A configuration of a control system 100 according to this embodiment is the same as that of Embodiment 1 illustrated in FIGS. 1 and 2.

A configuration of the shared backup ECU 101 according to this embodiment is the same as that of Embodiment 1 illustrated in FIG. 4.

***Description of Operation***

FIG. 9 illustrates an example of the management table 134 which additionally manages the execution CPU load of the SWC.

In the example of FIG. 9, when compared to the example of FIG. 6, a column of a CPU load level is added. The CPU loads can be accumulated such that the CPU loads do not exceed the CPU load capacity of the shared backup ECU 101 to which backup is enabled. In the example of FIG. 9, three shared backup ECUs 101 are provided for an on-vehicle equipment system in which five ECUs are primarily provided for automated driving. As the five ECUs for automated driving, an ECU1 which performs a function of road situation recognition, an ECU2 which performs a function of circumferential situation recognition, an ECU3 which performs a function of travel path generation, an ECU4 which performs a function of steering control, and an

ECUS which performs a function of engine control are provided. The SWCs of these ECUs are distributed among the backup-destination shared backup ECUs 101. The three shared backup ECUs 101 are a BECU1, a BECU2, and a BECU3. Assume that the maximum CPU load capacities of the BECU1, BECU2, and BECU3 are 60, 40, and 40, respectively.

As an example of CPU load calculation, SWC backup of a case where the ECU3 and ECU 4 fail will be described. In the ECU3, an SWC31, SWC32, and SWC33 are executed. In the ECU4, an SWC41, SWC42, and SWC43 are executed. Assume that ASIL-C SWCs and ASIL-D SWCs are backed up to the shared backup ECUs 101. Corresponding backup-target SWCs are three SWCs which are the SWC31, SWC41, and SWC42. The CPU load levels of the SWC31, SWC41, and SWC42 are 40, 20, and 10, respectively.

Processing for backup of the ASIL-D SWC31 and SWC41 which are important is performed first. For each of the SWC31 and SWC41, the first candidate of the backup-destination shared backup ECU 101 is the BECU1. The load upper limit of the BECU1 is 60. The total load of the SWC31 and the SWC41 is 60. Hence, both of the SWC31 and the SWC41 can be backed up to the BECU1. The in-use flags of the SWC31 and SWC41 are checked in order to indicate that each of the SWC31 and SWC41 has been backed up to the BECU1. If another failure should occur after that, the BECU1 is already full and another SWC cannot be additionally backed up to the BECU1.

Processing for backup of the SWC42 is performed next. The first candidate of the backup-destination shared backup ECU 101 is the BECU2. The load upper limit of the BECU2 is 40. The single load of the SWC42 is 10. Hence, the SWC42 can be backed up to the BECU2 without any problems. The in-use flag of the SWC42 is checked in order to indicate that the SWC42 has been backed up to the BECU2. If another failure should occur after that, since a load margin of 30 remains in the BECU2, additional SWC backup corresponding to this margin is possible.

In this manner, in this embodiment, when an abnormal unit is an ECU that executes two or more programs, an execution section 131 selects a program to be loaded by a loading section 135 in accordance with a size of a load of a processor 401 which is predicted for each program. When an abnormality in two or more ECUs is detected by a diagnostic section 132, the execution section 131 selects a program to be loaded by the loading section 135 in accordance with a size of a load of the processor 401 which is predicated for each combination of an ECU and a program.

The processing procedure of a shared backup program that operates within the shared backup ECU 101 is the same as that of Embodiment illustrated in FIG. 7 except for the backup-target SWC selection process of step S15. FIG. 10 illustrates the procedure of the backup-target SWC selection process. The process of step S41 and the process of S42 are the same as the process of step S31 and the process of S32, respectively, of FIG. 8. In step S43, the execution section 131 selects only the IDs of backup-target SWCs that can be backed up, among the IDs of the backup-target SWCs selected in step S42, based on the present CPU load status. In step S44, the execution section 131 turns on the in-use flags, within the management table 134, for the IDs of the backup-target SWCs which are selected in step S43.

***Description of Advantageous Effects of Embodiment***

In Embodiment 1, the number of SWCs of the backup-source ECU executed on the backup-destination shared backup ECU 101 is defined in advance. The execution CPU loads of the SWCs vary from a light load to a heavy load. Thus, in this embodiment, the execution CPU loads of the SWCs are managed by the management table 134 as well. That is, an execution-target SWC is added by calculation of the CPU load such that the CPU load stays equal to or under the upper limit value of the CPU performance. Therefore, the CPU of the shared backup ECU 101 can be utilized efficiently.

### Embodiment 3

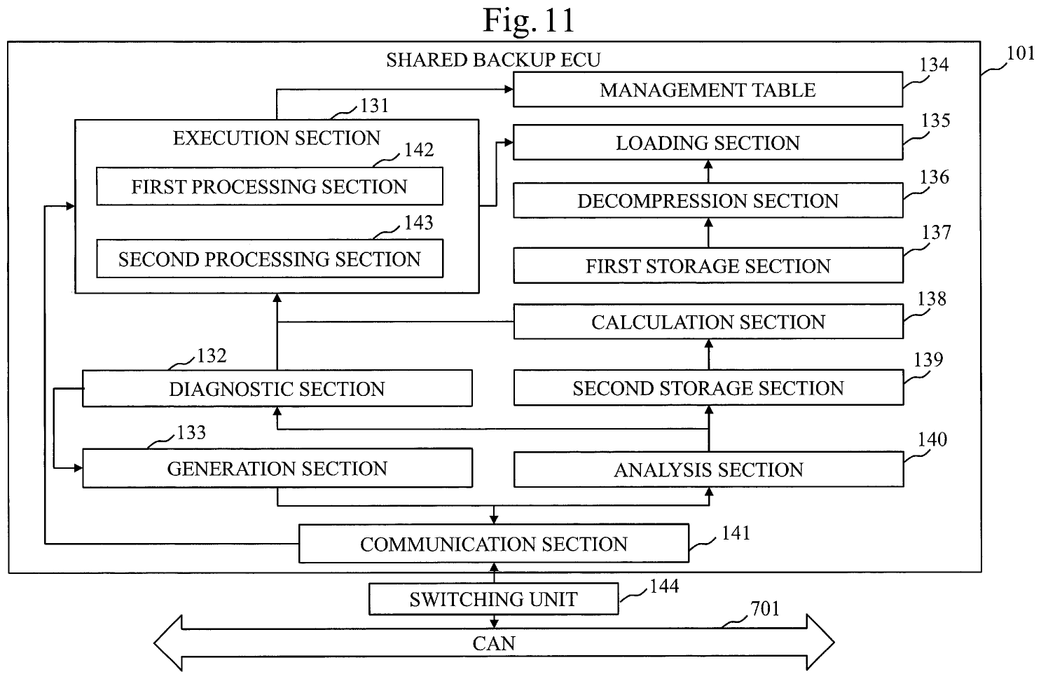

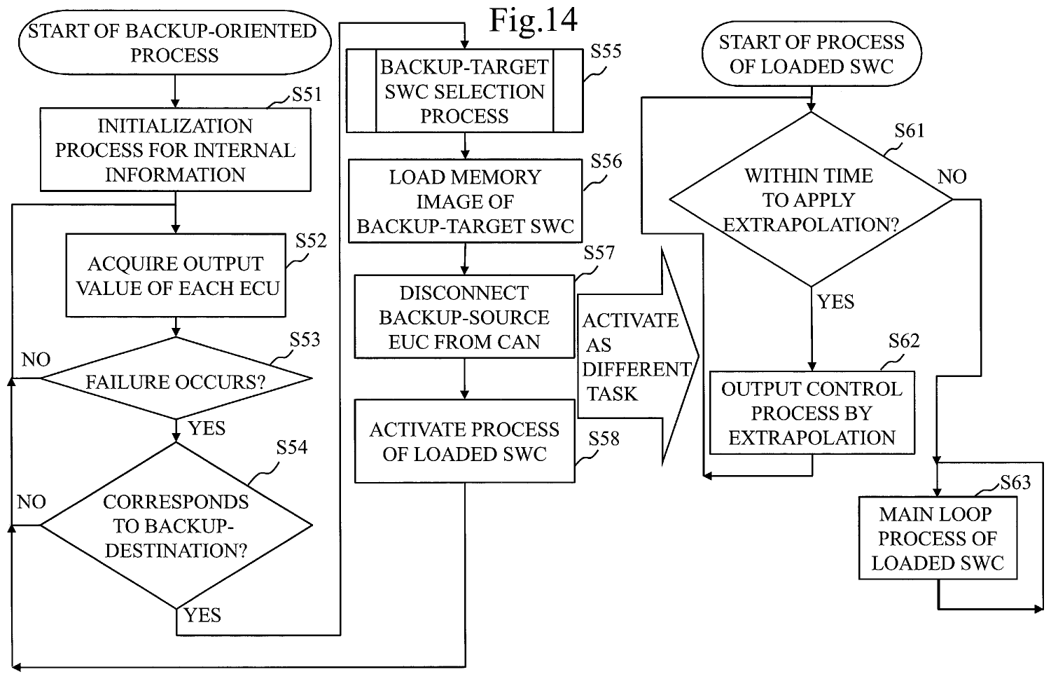

Embodiment 3 will be described mainly regarding differences from Embodiment 1 with reference to FIGS. 11 and 14.

In Embodiment 1, present information necessary for execution of a substitute software component for backup is transmitted from other plurality of ECUs to the shared backup ECU 101 as a message on a network, and stored in the second storage section 139. In Embodiment 3, instead of transmitting such present information as a message on the network, the content of a message on the network which is transmitted by an existing network transmission/reception process is analyzed, and succession of the process is performed with utilizing the analysis result. More specifically, a shared backup ECU 101, while not having present information of a failing ECU, predicts, by extrapolation, information that the software component of the failing ECU should have outputted after the failure, from information outputted by the software component of the failing ECU before the failure.

To save information on a state and learning of the failing ECU, which information is necessary for the continuous processing for backup, to an independent memory area of the shared backup ECU 101 by means of a CAN message or the like leads to consumption of the communication band of a CAN 701. Therefore, in this embodiment, instead of saving the state information of the running SWC to the save area periodically, the shared backup ECU 101 collects the existing CAN messages transmitted, and predicts an output control value by extrapolation, and performs the continuous processing.

***Description of Configuration***

A configuration of the shared backup ECU 101 according to this embodiment will be described with reference to FIG. 11.

The shared backup ECU 101 is further provided with a calculation section 138 as a functional element. The function of the calculation section 138 is implemented by software.

***Description of Operation***

In Embodiment 1, the CAN message information of the diagnosis-target ECU in a normal operation is transmitted from the analysis section 140 to the second storage section 139 and saved, as described with reference to FIG. 4. In Embodiment 1, internal variable information necessary for continuous execution of the SWC is placed on a CAN message, and the CAN message is transmitted from each SWC to the shared backup ECU 101. Hence, a CAN message for saving to the shared backup ECU 101 is transmitted additionally. This will increase the consumption of the communication band of the CAN 701. Therefore, the communication load need be estimated so the consumption amount will not become excessively large.

In this embodiment, an additional CAN message need not be transmitted. Basically, an existing CAN message transmitted from an SWC is utilized and analyzed in the shared backup ECU 101. When generating an output CAN message of a backup SWC, an output value predicted by extrapolation is calculated.

In this manner, in this embodiment, a communication section 141 receives, from a plurality of ECU, an individual message which the plurality of ECUs transmit as a program execution result. An execution section 131 predicts a state variable which an abnormal unit uses during program execution, based on a message received by the communication section 141 from the abnormal unit prior to detection of the abnormality by the diagnostic section 132. The execution section 131 sets a state variable to be used when executing a program loaded by a loading section 135, in accordance with the predicted state variable.

More specifically, assume that the diagnostic section 132 detects an abnormality in a control ECU 201. In this case, the execution section 131 predicts a state variable of a control SWC 202 from an output value of the control SWC 202, which is indicated by the CAN message received by the communication section 141 from the control ECU 201 before the abnormality is detected by the diagnostic section 132. The execution section 131 sets a state variable of a control SWC 111 loaded by the loading section 135, in accordance with the predicted state variable.

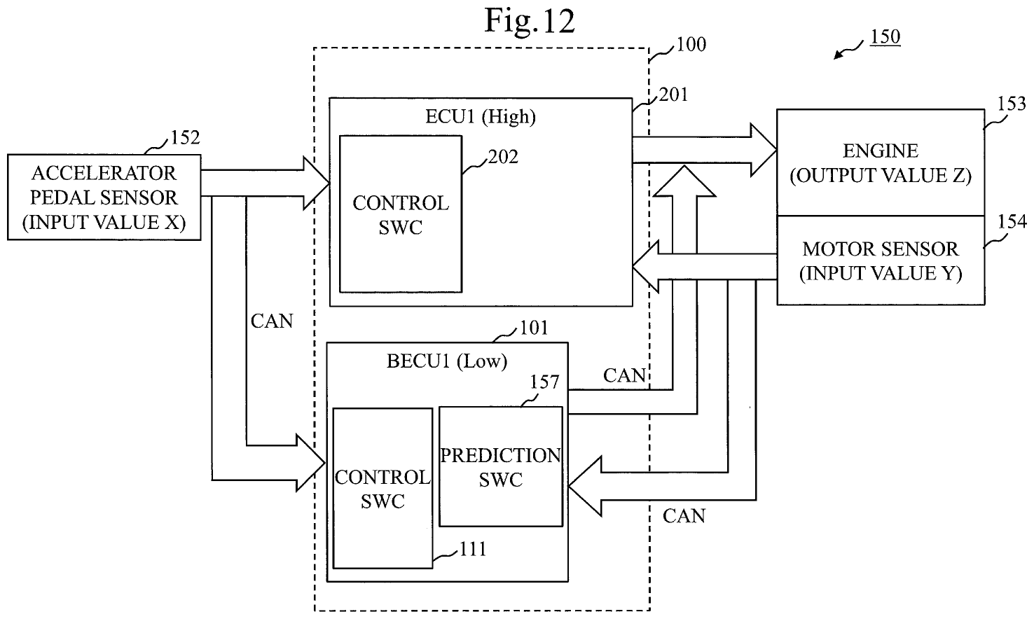

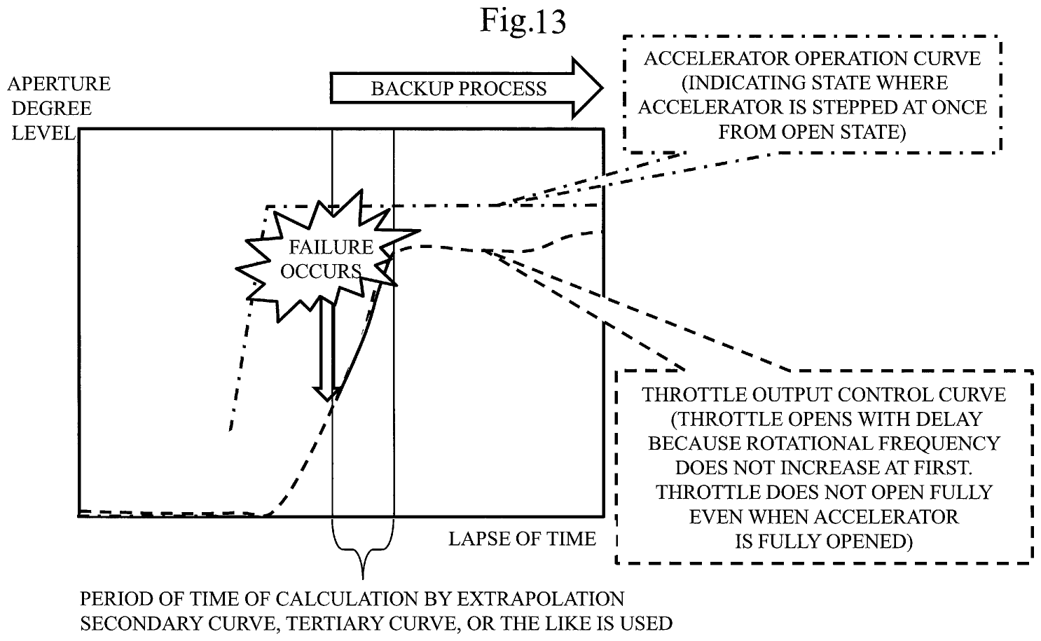

An electronic control throttle system 150 as illustrated in FIG. 12 will now be discussed as a specific example. This electronic control throttle system 150 is a mechanism that electrically connects and controls an accelerator pedal of an automobile and a throttle of an engine 153. Output control of the accelerator pedal and throttle is conducted according to a basic control pattern. There are accordingly few irregular cases and prediction by calculation is easy. For example, as a state of the engine 153, a so-called over venturi as illustrated in FIG. 13 exists. This refers to a state where before the engine 153 reaches a sufficient rotational frequency, even if a throttle is fully opened, the density of an intake air flow does not increase and the charging efficiency is poor. In order to avoid this state, in the electronic control throttle system 150, an output control value is calculated from an aperture degree of the throttle, a rotational frequency of the engine 153, and the like, in order to limit the aperture degree of the throttle at the time of opening the accelerator.

The electronic control throttle system 150 is provided with a control system 100, an accelerator pedal sensor 152 and a motor sensor 154 serving as input devices, and the engine 153 serving as an output device. The control system 100 is provided with a high-performance ECU 1 as the control ECU 201. The control system 100 is provided with a low-performance BECU1 as the shared backup ECU 101. Within the ECU1, the control SWC 202 which controls the output of the engine 153 is executed. When a failure occurs, the control SWC 111 on the BECU1 which controls the output of the engine 153 is executed. A prediction SWC 157 which calculates the predicted output value by extrapolation is executed on the BECU1 as well.

A calculation formula f to find an output value Z to the engine 153 from an input value X from the accelerator pedal sensor 152 for the control SWC 202 of the ECU1, an input value Y from the motor sensor 154 for the control SWC 202 of the ECU1, and internal variable information S of the control SWC 202 is:

Z=f(X, Y, S)

In the BECU1, the internal variable information S necessary for continuous execution of the control SWC 202 of the ECU1 is not provided by an CAN message like that in Embodiment 1, and is unknown. A calculation formula g to predict the output value Z by extrapolation is:

Z=g(X, Y)

The calculation section 138 obtains the engine output value Z by using the calculation g during a certain predetermined period of time immediately after backup of the control SWC 202 of the ECU1 is started. Basically, the internal variable information S can be obtained from the past state. Hence, after the lapse of the predetermined period of time described above, new internal variable information S can be predicted, so calculation of the output value Z by the calculation formula f is possible.

As the calculation formula g, a formula that represents an approximate curve such as a secondary curve and a tertiary curve is used. The output value Z can be calculated by a polynomial, a differential equation, or the like with using an existing method. In this embodiment, while the calculation method itself may be a conventional method, the output value at the time of the succession is predicted from an output value of the CAN message, for the sake of succession at the time of backup. This is the characteristic feature of this embodiment.

A processing procedure of a shared backup program which operates within the shared backup ECU 101 will be described with reference to FIG. 14.

The process of step S51 is the same as the process of step S11 of FIG. 7. The process of step S53 through step S58 is the same as the process of step 13 through step S18 of FIG. 7.

This processing procedure is different from that of Embodiment 1 illustrated in FIG. 7 mainly in the following two respects.

In step S12 of FIG. 7, the analysis section 140 acquires the present information including the internal variable information from each ECU being a backup source, by an additional CAN message. This additional CAN message is a message addressed to the shared backup ECU 101. In contrast, in step S52, an analysis section 140 acquires an output value for a device such as the engine 153, from a normal CAN message. This normal CAN message is not a message addressed to the shared backup ECU 101 but is a message addressed to the device such as the engine 153.

In step S21 of FIG. 7, the execution section 131 executes the main loop process of the loaded SWC. This main loop process is started immediately after the backup is started. In contrast, in this embodiment, an output control process by extrapolation is executed for a predetermined period of time, and after that a main loop process of a loaded SWC is started. More specifically, in step S61, the execution section 131 determines whether or not the predetermined period of time has elapsed. If the predetermined period of time has not elapsed, then in step S62, the calculation section 138 calculates an output value by the calculation formula g. The execution section 131 transmits the output value calculated by the calculation section 138 to a device such as the engine 153. If the predetermined period of time has elapsed, then in step S62, the execution section 131 executes the main loop process of the loaded SWC. In this main loop process, the execution section 131 calculates an output value by the calculation formula f. The execution section 131 transmits the calculated output value to the device such as the engine 153.

### Description of Advantageous Effects of Embodiment

In this embodiment, instead of saving information on a state and learning of the failing ECU, which information is necessary for the continuous processing for backup, to an independent memory area of the shared backup ECU 101 by means of an additional CAN message or the like, the CAN message transmitted usually is collected, and the output value is predicted by extrapolation. Therefore, a communication cost of the additional CAN message can be reduced, and consumption increase of the band of the network can be avoided.

In this embodiment, the CAN message transmitted usually is collected, and the output control value is predicted by extrapolation, thereby enabling continuous processing. As a result, modification of an SWC of the existing ECU is unnecessary in a system configuration where a backup ECU does not exist from the beginning. Since development to add the shared backup ECU 101 can be carried out separately and independently, the development efficiency improves.

### Embodiment 4

Embodiment 4 will be described mainly regarding differences from Embodiment 1.

In Embodiment 1, the number of cores of the built-in CPU of the shared backup ECU 101 is one. In this case, a plurality of OSs cannot be executed unless a hypervisor configuration is employed. The premise of Embodiment 1 is execution of a single OS, also due to the single-core hardware performance of the ECU. In Embodiment 4, a microcomputer having a built-in multicore CPU or a microcomputer having a built-in multiprocessor is employed as a shared backup ECU 101. For this reason, when different OSs such as AUTOSTAR (registered trademark) and Linux (registered trademark) are operated, corresponding SWCs can be executed continuously.

### Embodiment 5

Embodiment 5 will be described mainly regarding differences from Embodiment 1.

In Embodiment 1, the shared backup ECU 101 is shared within one network system. In Embodiment 5, although not illustrated, a plurality of network systems are connected by a gateway. A shared backup ECU 101 that can be shared by the plurality of network systems is located at the location of this gateway. When the shared backup ECU 101 is located on a network system having the highest communication speed, the communication efficiency improves.

### Embodiment 6

Embodiment 6 will be described mainly regarding differences from Embodiment 1.

The general trend is to connect a large number of ECUs to a CAN, and accordingly there is a concern about CAN ID exhaustion. In view of this, in this embodiment, instead of assigning individual CAN IDs to a plurality of shared backup ECUs 101, one CAN ID is assigned to the plurality of shared backup ECU 101 as a whole. In brief, the shared backup ECUs 101 of a group share one ID to monitor the existing ECU group and to perform a backup-oriented process when in emergency. Once the backup-oriented process is started, a local ID different from the CAN ID is stored in a CAN message as application information in order to perform distinction among the individual shared backup ECUs 101.

In this manner, in this embodiment, an individual message which is transmitted by the plurality of ECUs as the program execution result includes an identifier that is different according to the ECU, as the sender address. An individual message which the plurality of shared backup ECUs 101 transmit as the program execution result of an execution section 131 includes a common identifier as the sender address, and the identifier that is different according to the shared backup ECU 101, as part of transmission data. As the identifier that is different according to the ECU and as the common identifier, an ID of an arbitrary address architecture may be assigned, but in this embodiment, the CAN ID is assigned, as described above. As the identifier that is different according to the shared backup ECU 101, an ID of an arbitrary address architecture may be assigned, but in this embodiment, a local ID different from the CAN ID is assigned, as described above.

### Embodiment 7

Embodiment 7 will be described mainly regarding differences from Embodiment 1.

In Embodiment 1, various types of ECUs and the shared backup ECUs 101 are connected to the wired vehicle network such as the CAN 701. However, along with the nowaday dramatic increase of automobile ECUs, the CAN network cable wiring is becoming very complicated generally and network cable wiring is becoming difficult everywhere in automobile manufacture. In view of this, according to this embodiment, while a conventional wired network is employed for the conventional network communication, wireless network is employed for a limited application of a backup process at the time of failure. That is, the necessary backup communication process is carried out via the wireless network.

In a specific example, a plurality of shared backup ECUs 101 are accommodated together in one box. Wireless communication is performed between this box and a wireless gateway on a backbone CAN. With this configuration, a box for the shared backup ECUs 101 can be installed afterwards in an existing finished automobile network system without the need of considering the wiring.

### REFERENCE SIGNS LIST

100: control system; 101: shared backup ECU; 102: switching function; 103: analysis function; 104: loading function; 105: diagnostic function; 111: control SWC; 114: compressed image; 121: decision SWC; 124: compressed image; 131: execution section; 132: diagnostic section; 133: generation section; 134: management table; 135: loading section; 136: decompression section; 137: first storage section; 138: calculation section; 139: second storage section; 140: analysis section; 141: communication section; 142: first processing section; 143: second processing section; 144: switching unit; 150: electronic control throttle system; 152: accelerator pedal sensor; 153: engine; 154: motor sensor; 157: prediction SWC; 201: control ECU; 202: control SWC; 204: transmission function; 211: control ECU; 251: switching unit; 261: switching unit; 301: decision ECU; 302: decision SWC; 304: transmission function; 311: decision ECU; 351: switching unit; 361: switching unit; 401: processor; 402: memory; 403: CAN interface; 411: FPGA; 501: processor; 502: memory; 503: CAN interface; 511: FPGA; 601: processor; 602: memory; 603: CAN interface; 611: FPGA; 701: CAN; 711: CAN; 805: ASIL-D-oriented OS; 815: ASIL-C-oriented OS; 825: ASIL-B-oriented OS; 834: ASIL-D-oriented OS; 844: ASIL-D-oriented OS

1-9. (canceled)

10. A shared backup unit comprising:
processing circuitry
to diagnose an abnormality in a plurality of electronic control units which, in order to perform an individual function, execute a program that is different according to the function;
to load, from a storage section storing a plurality of programs in advance, a program which is the same as a program executed by an abnormal unit being an electronic control unit whose abnormality has been detected; and
to execute the program loaded, thereby performing a function which is the same as a function of the abnormal unit on behalf of the abnormal unit,
wherein when the abnormal unit is an electronic control unit that executes two or more programs, the processing circuitry selects a program to be loaded in accordance with a size of a load of a processor which is predicted for each program.

11. The shared backup unit according to claim 10,
wherein when the abnormal unit is an electronic control unit that executes two or more programs, the processing circuitry selects a program to be loaded according to a priority defined in advance for each program.

12. The shared backup unit according to claim 10,
wherein when an abnormality in two or more electronic control units is detected, the processing circuitry selects a program to be loaded according to a priority defined in advance for each combination of an electronic control unit and a program.

13. The shared backup unit according to claim 10,
wherein when an abnormality in two or more electronic control units is detected, the processing circuitry selects a program to be loaded by the loading section in accordance with a size of a load of a processor which is predicated for each combination of an electronic control unit and a program.

14. The shared backup unit according to claim 10,
wherein the processing circuitry receives an individual message indicating a state variable which the plurality of electronic control units use during execution of the program, from the plurality of electronic control units,
wherein the processing circuitry sets a state variable to be used when executing the program loaded, based on the messages received from the abnormal unit prior to detection of the abnormality.

15. A shared backup unit comprising:
processing circuitry
to diagnose an abnormality in a plurality of electronic control units which, in order to perform an individual function, execute a program that is different according to the function;
to load, from a storage section storing a plurality of programs in advance, a program which is the same as a program executed by an abnormal unit being an electronic control unit whose abnormality has been detected; and
to execute the program loaded, thereby performing a function which is the same as a function of the abnormal unit on behalf of the abnormal unit,
wherein the processing circuitry receives, from the plurality of electronic control units, an individual message which the plurality of electronic control units transmit as a program execution result,
wherein the processing circuitry predicts a state variable which the abnormal unit uses during program execution, based on a message received from the abnormal unit prior to detection of the abnormality, and sets a state variable to be used when executing the program loaded, in accordance with the predicted state variable.

16. A control system comprising:
a plurality of electronic control units which, in order to perform an individual function, execute a program that is different according to the function;
a plurality of shared backup units including:
processing circuitry
to diagnose an abnormality in a plurality of electronic control units;
to load, from a storage section storing a plurality of programs in advance, a program which is the same as a program executed by an abnormal unit being an electronic control unit whose abnormality has been detected; and
to execute the program loaded, thereby performing a function which is the same as a function of the abnormal unit on behalf of the abnormal unit,
wherein an individual message which the plurality of electronic control units transmit as a program execution result includes an identifier that is different according to the electronic control unit, as a sender address, and
wherein an individual message which the plurality of shared backup units transmit as the program execution result includes a common identifier as a sender address, and an identifier that is different according to the shared backup unit, as part of transmission data.

17. The control system according to claim 16,
wherein when the abnormal unit is an electronic control unit that executes two or more programs, the processing circuitry selects a program to be loaded in accordance with a size of a load of a processor which is predicted for each program.
